(19) United States
(12) Patent Application Publication
(10) Pub. No.: US 2007/0150627 A1
(43) Pub. Date: Jun. 28, 2007

(54) Endian mapping engine, method of endian mapping and a processing system employing the engine and the method

(75) Inventors: Judy M. Gehman, Fort Collins, CO (US); Steve M. Emerson, Chanhassen, MN (US)

Correspondence Address: LSI LOGIC CORPORATION, 1621 BARBER LANE, MS: D-106, MILPITAS, CA, 95035, US

(73) Assignee: LSI Logic Corporation, Milpitas, CA (US)

(21) Appl. No.: 11/284,864

(22) Filed: Nov. 22, 2005

(51) Int. Cl. G06F 13/38

(52) U.S. Cl. 710/70

(57) ABSTRACT

The present invention provides an endian mapping engine for use with a processing system. In one embodiment, the endian mapping engine includes an identification unit configured to identify sending and receiving endian schemes for data transfers between components of the processing system. Additionally, the endian scheme converter also includes a conversion unit coupled to the identification unit and configured to convert the data transfers between the sending and receiving endian schemes corresponding to an employed endian format. In an alternative embodiment, the endian mapping engine further includes a multiplexing unit coupled to the identification unit and configured to provide multiplexing between endian formats for a given endian scheme.

### TECHNICAL FIELD OF THE INVENTION

The present invention is directed, in general, to computer systems and, more specifically, to an endian mapping engine, a method of endian mapping and a processing system employing the engine or the method.

### BACKGROUND OF THE INVENTION

Endianness refers to the ordering of bytes of data in a multi-byte wide memory, or the sequence in which the bytes are transmitted over some medium usually when the data contains multiple bytes. There are different endian schemes supported by processors, buses, and peripherals today, which include byte invariant, word invariant and double-word invariant endian schemes. In little endian format, the least significant byte of data is stored in the lowest memory address in the range of addresses used to store the quantity. Alternatively, in big endian format, the most significant byte of data is stored in the lowest memory address in the range of addresses used to store the quantity. In little endian format, the bytes are steered to the same byte lanes for the same address when employing each of these three endian schemes. For big endian format, however, the bytes are located in different byte lanes for the same address based on the endian scheme used.

Typically the processor, bus and peripherals for a processing system design use the same endian scheme whether it is byte, word or double-word invariant. For example, the processing system using an ARM9 processor, AMBA AHB/APB buses and associated peripherals would be designed to use a word invariant endian scheme throughout. However, by limiting the processing system design to one endiah scheme, advantages afforded by using different bus architectures and processor features to improve overall performance of the system may be sacrificed. Alternatively, for example, an application may advantageously employ a processing system having the MIPS processor using double-word invariant, the ARM Ltd. AMBA AXI bus using byte invariant, and the ARM Ltd. AMBA AHB/APB buses using word invariant endian schemes.

Additionally, by limiting the processing system design to components of the same endian scheme, time-to-market constraints may arise in addition to performance issues. For example, various peripherals may have been developed and maintained that already use one or more of a particular endian format and scheme. The capability to reuse these peripherals with a variety of processing system designs eliminates redesign and verification efforts thereby reducing both time-to-market concerns and development costs.

Accordingly, what is needed in the art is a way to resolve different endian schemes and formats used by various components of a processing system.

### SUMMARY OF THE INVENTION

To address the above-discussed deficiencies of the prior art, the present invention provides an endian mapping engine for use with a processing system. In one embodiment, the endian mapping engine includes an identification unit configured to identify sending and receiving endian schemes for data transfers between components of the processing system. Additionally, the endian mapping engine also includes a conversion unit coupled to the identification unit and configured to convert the data transfers between the sending and receiving endian schemes corresponding to an employed endian format. In an alternative embodiment, the endian mapping engine further includes a multiplexing unit coupled to the identification unit and configured to provide multiplexing between endian formats for a given endian scheme.

In another aspect, the present invention provides a method of endian mapping for use with a processing system. The method includes identifying sending and receiving endian schemes for data transfers between components of the processing system and converting the data transfers between the sending and receiving endian schemes corresponding to an employed endian format.

The present invention also provides, in yet another aspect, a processing system including a processor block employing at least one processing unit, an interconnect block, coupled to the processor block, employing an input-output bus and a peripheral block, coupled to the interconnect block, employing at least one peripheral. The processing system also includes an endian mapping engine coupled to the processor, interconnect and peripheral blocks having an identification unit that identifies sending and receiving endian schemes for data transfers between components of the processing system. The endian mapping engine also has a conversion unit, coupled to the identification unit, which converts the data transfers between the sending and receiving endian schemes corresponding to an employed endian format.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a processing system constructed in accordance with the principles of the present invention;

FIG. 2 illustrates an expanded block diagram of an embodiment of a processing system constructed in accordance with the principles of the present invention; and

FIG. 3 illustrates a flow diagram of an embodiment of a method of endian mapping carried out in accordance with the principles of the present invention.

### DETAILED DESCRIPTION

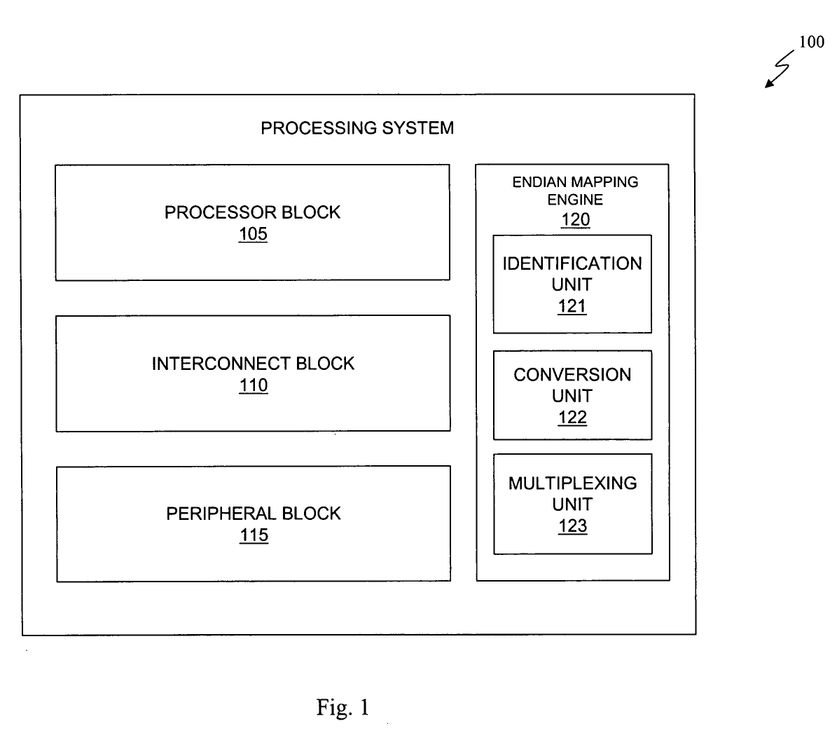

Referring initially to FIG. 1, illustrated is a block diagram of an embodiment of a processing system, generally designated 100, constructed in accordance with the principles of the present invention. The processing system 100 includes a processor block 105, an interconnect block 110, a peripheral block 115 and an endian mapping engine 120. The endian mapping engine 120 includes an identification unit 121, a conversion unit 122 and a multiplexing unit 123.

The processor block 105 employs at least one processor and may employ a plurality of processors as appropriate to a particular application. The interconnect block 110 is coupled to the processor block 105 and typically employs a plurality of input-output buses although only one may be required. The peripheral block 115 is coupled to the interconnect block 110 and employs at least one peripheral wherein a plurality is usually required.

The endian mapping engine 120 is coupled to the processor, interconnect and peripheral blocks 105, 110, 115. The identification unit 121 identifies sending and receiving endian schemes for data transfers between components of the processing system 100. The conversion unit 122 is coupled to the identification unit 121 and converts the data transfers between the sending and receiving endian schemes corresponding to an employed endian format. The multiplexing unit 123 is coupled to the identification unit 121 and provides multiplexing between endian formats, when both big and little endian formats are not employable for a given endian scheme.

The endian scheme employed for data transfers is selected from the group consisting of byte invariant, half-word invariant, word invariant and double-word invariant Additionally, the endian format is selected from the group consisting of a little endian format and a big endian format. In general, each of the sending and receiving endian schemes may be identified employing at least one of a static and a dynamic endianness signal, usually indicated by the processor block 105. In the illustrated embodiment, each component of the processing system 100 sends and receives data employing its native endian scheme.

Byte invariant means that a byte transfer to a given address passes the eight bits of data on the same data bus wires to the same address location regardless of endianness. Therefore, for a given transaction request size (i.e., byte, half-word or word) in a byte invariant system, the address of each byte of memory remains unchanged when switching between little endian and big endian operation. Alternatively, in a word invariant system, the address of each byte of memory changes when switching between little and big endian operation, but words stored in a multiword address would not change between big and little endian.

Additionally, byte steering is employed to convert the data transfers between the sending and receiving endian schemes. In the illustrated embodiment, the byte steering corresponds to the big endian format and the processing block 105 has a processor that employs a hardware signal to indicate the use of the big endian format.

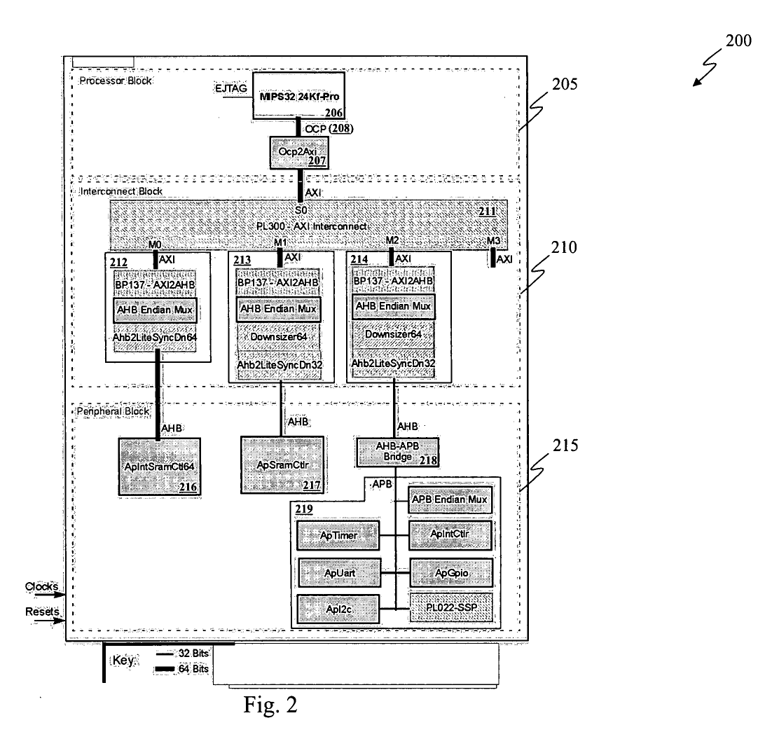

Turning now to FIG. 2, illustrated is an expanded block diagram of an embodiment of a processing system, generally designated 200, constructed in accordance with the principles of the present invention. The processing system 200 includes a processor block 205, an interconnect block 210 and a peripheral block 215. The processing block 205 includes a MIPS processor 206 connected to an OCP (Open Core Protocol Specification) to AXI (Ocp2Axi) bridge 207 employing an OCP bus 208. The interconnect block 210 includes a 64-bit AXI interconnect 211, a 64-bit AXI to 64-bit AHB bus structure 212 and first and second 64-bit AXI to 32-bit AHB bus structures 213, 214. The peripheral block 215 includes a 64-bit AHB peripheral 216, a 32-bit AHB peripheral 217, a 32-bit AHB-to-APB bridge 218 that accommodates a collection of 32-bit APB peripherals 219.

For more information regarding the commercially available components shown in FIG. 2, one skilled in the pertinent art is referred to:
1) MIPS32® 24K™ Processor Core Family Datasheet from MIPS Technologies,
2) Open Core Protocol Specification from OCP International Partnership (OCP-IP),
3) AMBA AXI Protocol Specification from ARM Limited and
4) AMBA 2.0 or 3.0 Specification from ARM Limited,
   which are incorporated herein by reference. This information may also be available at (www.mips.com), (www.ocpip.org) and (www.arm.com), respectively. The data associated with the processing system 200 crosses several different bus architectures. The different endian schemes associated with the processor, buses, and peripherals need to be identified to ensure that the data is properly understood by each component in the system.

The MIPS processor 206 has an input static signal to configure the core to support big or little endian. Table 1 shows endian byte lane usage for the MIPS processor 206. Table 1 shows that the MIPS processor 206 supports a double-word invariant endian scheme since the data is identical for 64-bit transfers for both big and little endian formats. The differences with respect to endianness are only visible for sub-double-word references.

TABLE 1
MIPS Processor Endian Byte Lane Usage

| MIPS | | | | |
|---|---|---|---|---|
| Internal | | | | |
| Addrs | Big Endian | | Little Endian | |
| [2:0] | OC_MData[63:0] | OC_MDataByteEn [7:0] | OC_MData[63:0] | OC_MDataByteEn [7:0] |
| 0 | 0xef-------------- | 10000000 | 0x--------------ef | 00000001 |
| 1 | 0x--ef------------ | 01000000 | 0x------------ef-- | 00000010 |
| 2 | 0x----ef---------- | 00100000 | 0x----------ef---- | 00000100 |
| 3 | 0x------ef-------- | 00010000 | 0x--------ef------ | 00001000 |
| 4 | 0x--------ef------ | 00001000 | 0x------ef-------- | 00010000 |
| 5 | 0x----------ef---- | 00000100 | 0x----ef---------- | 00100000 |
| 6 | 0x------------ef-- | 00000010 | 0x--ef------------ | 01000000 |
| 7 | 0x--------------ef | 00000001 | 0xef-------------- | 10000000 |
| 0 | 0xcdef------------ | 11000000 | 0x------------cdef | 00000011 |
| 2 | 0x----cdef-------- | 00110000 | 0x--------cdef---- | 00001100 |
| 4 | 0x--------cdef---- | 00001100 | 0x----cdef-------- | 00110000 |
| 6 | 0x------------cdef | 00000011 | 0xcdef------------ | 11000000 |
| 0 | 0x89abcdef-------- | 11110000 | 0x--------89abcdef | 00001111 |
| 4 | 0x--------89abcdef | 00001111 | 0x89abcdef-------- | 11110000 |
| 0 | 0x0123456789abcdef | 11111111 | 0x0123456789abcdef | 11111111 |

The OCP bus 208 is endian-neutral, since the master and slave are the same bus width, in the illustrated embodiment. OCP addressing in this system is on a double-word granularity. For a 64-bit data bus width, the lower three bits of the address are always ignored. The OCP MAddr signal is aligned with this 64-bit word size.

The AXI bus (ARM Ltd.) uses a byte invariant endian scheme and is not endian-neutral like the OCP bus 208. The read address channel does not have byte strobes, but uses the lower three address bits and the ARSIZE signal to determine where the bytes should be steered. The write address channel uses write strobes (byte enables), the lower three address bits and the AWSIZE signal. For write operations, the AXI slave may use either the write strobes or address and AWSIZE information to determine where the bytes should be steered.

The AHB and APB buses (ARM Ltd.) use a word invariant endian scheme, where a word in this bus architecture is considered to be 32-bits wide. Word transfers are identical using big or little endian formats. The differences with respect to endianness are only visible for sub-word references. For AHB and APB buses of 64-bits wide, the data are treated as individual 32-bit wide units.

In the illustrated embodiment of FIG. 2, the data from the MIPS double-word invariant endian scheme needs to be converted to the AXI byte invariant endian scheme and then to the AHB/APB word invariant endian scheme. The following discussion indicates how conversion between these endian schemes may be accomplished. Little and big endian formats will be considered separately, and the following nomenclature will be used:

LE-64 refers to double-word invariant little endian,

LE-32 refers to word invariant little endian,

LE-8 refers to byte invariant little endian,

BE-64 refers to double-word invariant big endian,

BE-32 refers to word invariant big endian, and

BE-8 refers to byte invariant big endian.

In little endian format, the least significant byte is stored in the lowest memory address in the range of addresses used to store the quantity. Table 2, Table 3, Table 4, and Table 5 show how the byte lanes are specified using the lower address bits for byte, half-word, word, and double-word accesses for LE-8, LE-32 and LE-64. In these tables, the numbers 0-7 represent byte, half-word, word or double-word associated with that part of the data bus where 0 represents the least significant and 7 the most significant. For example, in Table 2 when transferring a byte of data to address[2:0]=b000, byte lane 7:0 is used for LE-8, 7:0 for LE-32 and 7:0 for LE-64. When transferring a byte of data to address[2:0]=b111, byte lane 63:56 is used for LE-8, LE-32 and LE-64.

TABLE 2
Little Endian Byte Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |
| LE-8 | 7 | 6 | 5 | 4 | 3 | 2 | 1 | 0 |
| LE-32 | 7 | 6 | 5 | 4 | 3 | 2 | 1 | 0 |
| LE-64 | 7 | 6 | 5 | 4 | 3 | 2 | 1 | 0 |

¹Byte 0 is accessed with Addr [2:0] = b000, Byte 1 is accessed with Addr[2:0] = b001, Byte 2 is accessed with Addr[2:0] = b010, Byte 3 is accessed with Addr[2:0] = b011, Byte 4 is accessed with Addr[2:0] = b100, Byte 5 is accessed with Addr[2:0] = b101, Byte 6 is accessed with Addr[2:0] = b110, Byte 7 is accessed with Addr[2:0] = b111

TABLE 3
Little Endian Half-word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | | | | |
|---|---|---|---|---|
| LE-8 | 3 | 2 | 1 | 0 |
| LE-32 | 3 | 2 | 1 | 0 |
| LE-64 | 3 | 2 | 1 | 0 |

¹Half-word 0 is accessed with Addr[2:0] = b000, Half-word 1 is accessed with Addr[2:0] = b010, Half-word 2 is accessed with Addr[2:0] = b100, Half-word 3 is accessed with Addr[2:0] = b110

TABLE 4
Little Endian Word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | | |
|---|---|---|
| LE-8 | 1 | 0 |
| LE-32 | 1 | 0 |
| LE-64 | 1 | 0 |

¹Word 0 is accessed with Addr[2:0] = b000, Word 1 is accessed with Addr[2:0] = b100

TABLE 5
Little Endian Double-Word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | |
|---|---|
| LE-8 | 0 |
| LE-32 | 0 |
| LE-64 | 0 |

¹Double-word 0 is accessed with Addr[2:0] = b000

Table 6 specifies the conversion between the byte, word and double-word invariant endian schemes for little endian formats. The relationship of byte lane to lower address bits (Addr[2:0]) and transfer size (A*SIZE, HSIZE) specified in Tables 2, 3, 4, and 5 are applied to Table 6. Table 6 uses the following values for byte, half-word, word and double-word examples:

byte=0x0

half word=0x10

word:=0x3210

double-word=0x76543210

Table 6 shows that no byte steering is needed to convert between byte, word and double-word invariant endian schemes for little endian formats. For the same address, byte enables, AWSIZE, ARSIZE and HSIZE settings, the bytes of data are placed in the same byte lanes for each endian scheme.

TABLE 6
Conversion between LE-8, LE-32 and LE-64

| Bus | | Byte | A*SIZE | Data Bus | | | | | | | |
|---|---|---|---|---|---|---|---|---|---|---|---|
| Type | Addr[2:0] | En¹ | HSIZE² | 63:56 | 55:48 | 47:40 | 39:32 | 31:24 | 23:16 | 15:8 | 7:0 |
| LE-8 | 000 | 0x01 | 000 | | | | | | | | 0 |
| LE-32 | 000 | 0x01 | 000 | | | | | | | | 0 |
| LE-64 | 000 | 0x01 | 000 | | | | | | | | 0 |
| LE-8 | 001 | 0x02 | 000 | | | | | | | 0 | |
| LE-32 | 001 | 0x02 | 000 | | | | | | | 0 | |
| LE-64 | 001 | 0x02 | 000 | | | | | | | 0 | |
| LE-8 | 010 | 0x04 | 000 | | | | | | 0 | | |
| LE-32 | 010 | 0x04 | 000 | | | | | | 0 | | |
| LE-64 | 010 | 0x04 | 000 | | | | | | 0 | | |
| LE-8 | 011 | 0x80 | 000 | | | | | 0 | | | |
| LE-32 | 011 | 0x80 | 000 | | | | | 0 | | | |
| LE-64 | 011 | 0x80 | 000 | | | | | 0 | | | |
| LE-8 | 100 | 0x10 | 000 | | | | 0 | | | | |
| LE-32 | 100 | 0x10 | 000 | | | | 0 | | | | |
| LE-64 | 100 | 0x10 | 000 | | | | 0 | | | | |
| LE-8 | 101 | 0x20 | 000 | | | 0 | | | | | |
| LE-32 | 101 | 0x20 | 000 | | | 0 | | | | | |
| LE-64 | 101 | 0x20 | 000 | | | 0 | | | | | |
| LE-8 | 110 | 0x40 | 000 | | 0 | | | | | | |
| LE-32 | 110 | 0x40 | 000 | | 0 | | | | | | |
| LE-64 | 110 | 0x40 | 000 | | 0 | | | | | | |
| LE-8 | 111 | 0x80 | 000 | 0 | | | | | | | |
| LE-32 | 111 | 0x80 | 000 | 0 | | | | | | | |
| LE-64 | 111 | 0x80 | 000 | 0 | | | | | | | |
| LE-8 | 000 | 0x03 | 001 | | | | | | | 1 | 0 |
| LE-32 | 000 | 0x03 | 001 | | | | | | | 1 | 0 |
| LE-64 | 000 | 0x03 | 001 | | | | | | | 1 | 0 |
| LE-8 | 010 | 0x0C | 001 | | | | | 1 | 0 | | |
| LE-32 | 010 | 0x0C | 001 | | | | | 1 | 0 | | |
| LE-64 | 010 | 0x0C | 001 | | | | | 1 | 0 | | |
| LE-8 | 100 | 0x30 | 001 | | | 1 | 0 | | | | |
| LE-32 | 100 | 0x30 | 001 | | | 1 | 0 | | | | |
| LE-64 | 100 | 0x30 | 001 | | | 1 | 0 | | | | |
| LE-8 | 110 | 0xC0 | 001 | 1 | 0 | | | | | | |
| LE-32 | 110 | 0xC0 | 001 | 1 | 0 | | | | | | |
| LE-64 | 110 | 0xC0 | 001 | 1 | 0 | | | | | | |
| LE-8 | 000 | 0x0F | 010 | | | | | 3 | 2 | 1 | 0 |
| LE-32 | 000 | 0x0F | 010 | | | | | 3 | 2 | 1 | 0 |
| LE-64 | 000 | 0x0F | 010 | | | | | 3 | 2 | 1 | 0 |
| LE-8 | 100 | 0xF0 | 010 | 3 | 2 | 1 | 0 | | | | |
| LE-32 | 100 | 0xF0 | 010 | 3 | 2 | 1 | 0 | | | | |
| LE-64 | 100 | 0xF0 | 010 | 3 | 2 | 1 | 0 | | | | |
| LE-8 | 000 | 0xEF | 011 | 7 | 6 | 5 | 4 | 3 | 2 | 1 | 0 |
| LE-32 | 000 | 0xFF | 011 | 7 | 6 | 5 | 4 | 3 | 2 | 1 | 0 |
| LE-64 | 000 | 0xFF | 011 | 7 | 6 | 5 | 4 | 3 | 2 | 1 | 0 |

¹Byte En represents the OCP and AXI bus byte enables or write strobes depending on the bus terminology. Each active high bit represents a valid byte.
²A*SIZE represents the AXI signals AWSIZE and ARSIZE that represent the write and read burst size respectively. HSIZE is the AHB bus burst size indicator. 000 = byte, 001 = half-word, 010 = word, and 011 = double-word transfers.

In big endian format, the most significant byte is stored in the lowest memory address in the range of addresses used to store the quantity. Table 7, Table 8, Table 9 and Table 10 show how the byte lanes are specified using the lower address bits for byte, half-word, word and double-word accesses for BE-8, BE-32 and BE-64. In these tables, the numbers 0-7 represent byte, half-word, word or double-word associated with that part of the data bus where 0 represents the least significant and 7 the most significant, as before. For example, in Table 7 when transferring a byte of data to address[2:0]=b000, byte lane 7:0 is used for BE-8, 31:24 for BE-32 and 63:56 for BE-64. When transferring a byte of data to address[2:0]=b111, byte lane 63:56 is used for BE-8, 39:32 for BE-32 and 7:0 for BE-64.

TABLE 7
Big Endian Byte Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |
| BE-8 | 7 | 6 | 5 | 4 | 3 | 2 | 1 | 0 |
| BE-32 | 4 | 5 | 6 | 7 | 0 | 1 | 2 | 3 |
| BE-64 | 0 | 1 | 2 | 3 | 4 | 5 | 6 | 7 |

¹Byte 0 is accessed with Addr[2:0] = b000, Byte 1 is accessed with Addr[2:0] = b001, Byte 2 is accessed with Addr[2:0] = b010, Byte 3 is accessed with Addr[2:0] = b011, Byte 4 is accessed with Addr[2:0] = b100, Byte 5 is accessed with Addr[2:0] = b101, Byte 6 is accessed with Addr[2:0] = b110, Byte 7 is accessed with Addr[2:0] = b111

TABLE 8
Big Endian Half-word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | | | | |
|---|---|---|---|---|
| BE-8 | 3 | 2 | 1 | 0 |
| BE-32 | 2 | 3 | 0 | 1 |
| BE-64 | 0 | 1 | 2 | 3 |

¹Half-word 0 is accessed with Addr[2:0] = b000, Half-word 1 is accessed with Addr[2:0] = b010, Half-word 2 is accessed with Addr[2:0] = b100, Half-word 3 is accessed with Addr[2:0] = b110

TABLE 9
Big Endian Word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | | |
|---|---|---|
| BE-8 | 1 | 0 |
| BE-32 | 1 | 0 |
| BE-64 | 0 | 1 |

¹Word 0 is accessed with Addr[2:0] = b000, Word 1 is accessed with Addr[2:0] = b100

TABLE 10
Big Endian Double-Word Numbering

| Bus | Data Bus¹ | | | | | | | |
|---|---|---|---|---|---|---|---|---|
| Type | 63:56 | 55:48 | 47:40 | 39:32 | 31:24 | 23:16 | 15:8 | 7:0 |

| | |
|---|---|
| BE-8 | 0 |
| BE-32 | 0 |
| BE-64 | 0 |

¹Double-word 0 is accessed with Addr[2:0] = b000

Table 11 specifies the conversion between the byte, word and double-word invariant endian schemes for big endian formats. The relationship of byte lane to lower address bits (Addr[2:0]) and transfer size (A*SIZE, HSIZE) specified in Tables 7, 8, 9 and 10 are applied to Table 11. Table 11 uses the following values for byte, half-word, word, and double-word examples:

byte=0x0

half word=0x10

word:=0x3210

double-word=0x76543210

Table 11 clearly shows that byte steering is needed to convert between byte, word and double-word invariant endian schemes for big endian formats. For the same address, byte enables, A*SIZE and HSIZE settings, the data bytes are placed in different byte lanes for each endian scheme.

TABLE 11
Conversion between BE-8, BE-32 and BE-64 Bus

| Bus | | Byte | A*SIZE | Data Bus | | | | | | | |
|---|---|---|---|---|---|---|---|---|---|---|---|
| Type | Addr[2:0] | En¹ | HSIZE² | 63:56 | 55:48 | 47:40 | 39:32 | 31:24 | 23:16 | 15:8 | 7:0 |
| BE-8 | 000 | 0x01 | 000 | | | | | | | | 0 |
| BE-32 | 000 | 0x08 | 000 | | | | | 0 | | | |
| BE-64 | 000 | 0x80 | 000 | 0 | | | | | | | |
| BE-8 | 001 | 0x02 | 000 | | | | | | | 0 | |
| BE-32 | 001 | 0x04 | 000 | | | | | | 0 | | |
| BE-64 | 001 | 0x40 | 000 | | 0 | | | | | | |
| BE-8 | 010 | 0x04 | 000 | | | | | | 0 | | |
| BE-32 | 010 | 0x02 | 000 | | | | | | | 0 | |
| BE-64 | 010 | 0x20 | 000 | | | 0 | | | | | |
| BE-8 | 011 | 0x08 | 000 | | | | | 0 | | | |
| BE-32 | 011 | 0x01 | 000 | | | | | | | | 0 |
| BE-64 | 011 | 0x10 | 000 | | | | 0 | | | | |
| BE-8 | 100 | 0x10 | 000 | | | | 0 | | | | |
| BE-32 | 100 | 0x80 | 000 | 0 | | | | | | | |
| BE-64 | 100 | 0x08 | 000 | | | | | 0 | | | |
| BE-8 | 101 | 0x20 | 000 | | | 0 | | | | | |
| BE-32 | 101 | 0x40 | 000 | | 0 | | | | | | |
| BE-64 | 101 | 0x04 | 000 | | | | | | 0 | | |
| BE-8 | 110 | 0x40 | 000 | | 0 | | | | | | |
| BE-32 | 110 | 0x20 | 000 | | | 0 | | | | | |
| BE-64 | 110 | 0x02 | 000 | | | | | | | 0 | |
| BE-8 | 111 | 0x80 | 000 | 0 | | | | | | | |
| BE-32 | 111 | 0x10 | 000 | | | | 0 | | | | |
| BE-64 | 111 | 0x01 | 000 | | | | | | | | 0 |
| BE-8 | 000 | 0x03 | 001 | | | | | | | 0 | 1 |
| BE-32 | 000 | 0x0C | 001 | | | | | 1 | 0 | | |
| BE-64 | 000 | 0xC0 | 001 | 1 | 0 | | | | | | |
| BE-8 | 010 | 0x0C | 001 | | | | | 0 | 1 | | |
| BE-32 | 010 | 0x03 | 001 | | | | | | | 1 | 0 |
| BE-64 | 010 | 0x30 | 001 | | | 1 | 0 | | | | |
| BE-8 | 100 | 0x30 | 001 | | | 0 | 1 | | | | |
| BE-32 | 100 | 0xC0 | 001 | 1 | 0 | | | | | | |
| BE-64 | 100 | 0x0C | 001 | | | | | 1 | 0 | | |
| BE-8 | 110 | 0xC0 | 001 | 0 | 1 | | | | | | |
| BE-32 | 110 | 0x30 | 001 | | | 1 | 0 | | | | |
| BE-64 | 110 | 0x03 | 001 | | | | | | | 1 | 0 |
| BE-8 | 000 | 0x0F | 010 | | | | | 0 | 1 | 2 | 3 |
| BE-32 | 000 | 0x0F | 010 | | | | | 3 | 2 | 1 | 0 |
| BE-64 | 000 | 0xF0 | 010 | 3 | 2 | 1 | 0 | | | | |
| BE-8 | 100 | 0x0F | 010 | 0 | 1 | 2 | 3 | | | | |
| BE-32 | 100 | 0xF0 | 010 | 3 | 2 | 1 | 0 | | | | |
| BE-64 | 100 | 0x0F | 010 | | | | | 3 | 2 | 1 | 0 |
| BE-8 | 000 | 0xFF | 011 | 0 | 1 | 2 | 3 | 4 | 5 | 6 | 7 |
| BE-32 | 000 | 0xFF | 011 | 3 | 2 | 1 | 0 | 7 | 6 | 5 | 4 |
| BE-64 | 000 | 0xFF | 011 | 7 | 6 | 5 | 4 | 3 | 2 | 1 | 0 |

¹Byte En represents the OCP and AXI bus byte enables or write strobes depending on the bus terminology. Each active high bit represents a valid byte.
²A*SIZE represents the AXI signals AWSIZE and ARSIZE that represent the write and read burst size respectively. HSIZE is the AHB bus burst size indicator. 000 = byte, 001 = half-word, 010 = word, and 011 = double-word transfers.

Table 12, Table 13, Table 14, Table 15, Table 16, Table 17, and Table 18 show examples of byte, half-word, word and double-word transfers employing a little endian format from the MIPS processor to the AHB/APB bus. For these examples the following values are used:

byte=0xef

half-word=0xcdef

word=0x89abcdef

double-word=0x0123456789abcdef

TABLE 12
Little Endian - Byte Transfer (0xef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | |
|---|---|---|---|---|
| MIPS | 000 | 0x01 | n/a | ef |
| OCP | n/a | 0x01 | n/a | ef |
| AXI | 000 | 0x01 | 000 | ef |
| AHB/APB | 000 | n/a | 000 | ef |

TABLE 13
Little Endian - Byte Transfer (0xef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | |
|---|---|---|---|---|
| MIPS | 111 | 0x80 | n/a | ef |
| OCP | n/a | 0x80 | n/a | ef |
| AXI | 111 | 0x80 | 000 | ef |
| AHB/APB | 111 | n/a | 000 | ef |

TABLE 14
Little Endian - Half-Word Transfer (0xcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | |
|---|---|---|---|---|---|
| MIPS | 000 | 0x03 | n/a | cd | ef |
| OCP | n/a | 0x03 | n/a | cd | ef |
| AXI | 000 | 0x03 | 001 | cd | ef |
| AHB/APB | 000 | n/a | 001 | cd | ef |

TABLE 15
Little Endian - Half-Word Transfer (0xcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | |
|---|---|---|---|---|---|
| MIPS | 110 | 0xC0 | n/a | cd | ef |
| OCP | n/a | 0xC0 | n/a | cd | ef |
| AXI | 110 | 0xC0 | 001 | cd | ef |
| AHB/APB | 110 | n/a | 001 | cd | ef |

TABLE 16
Little Endian - Word Transfer (0x89abcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | | | |
|---|---|---|---|---|---|---|---|
| MIPS | 000 | 0x0F | n/a | 89 | ab | cd | ef |
| OCP | n/a | 0x0F | n/a | 89 | ab | cd | ef |
| AXI | 000 | 0x0F | 010 | 89 | ab | cd | ef |
| AHB/APB | 000 | n/a | 010 | 89 | ab | cd | ef |

TABLE 17
Little Endian - Word Transfer (0x89abcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | | | |
|---|---|---|---|---|---|---|---|
| MIPS | 100 | 0xF0 | n/a | 89 | ab | cd | ef |
| OCP | n/a | 0xF0 | n/a | 89 | ab | cd | ef |
| AXI | 100 | 0xF0 | 010 | 89 | ab | cd | ef |
| AHB/APB | 100 | n/a | 010 | 89 | ab | cd | ef |

TABLE 18
Little Endian - Double-Word Transfer (0x0123456789abcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |
| MIPS | 000 | 0xFF | n/a | 01 | 23 | 45 | 67 | 89 | ab | cd | ef |
| OCP | n/a | 0xFF | n/a | 01 | 23 | 45 | 67 | 89 | ab | cd | ef |
| AXI | 000 | 0xFF | 011 | 01 | 23 | 45 | 67 | 89 | ab | cd | ef |
| AHB/APB | 000 | n/a | 011 | 01 | 23 | 45 | 67 | 89 | ab | cd | ef |

Table 19, Table 20, Table 21, Table 22, Table 23, Table 24, and Table 25 show examples of byte, half-word, word, and double-word transfers employing a big endian format from the MIPS processor to the AHB/APB bus. For these examples the following values are used:

byte=0xef

half-word=0xcdef

word=0x89abcdef

double-word=0x0123456789abcdef

TABLE 19
Big Endian - Byte Transfer (0xef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | | |
|---|---|---|---|---|---|---|
| MIPS | 000 | 0x80 | n/a | ef | | |
| OCP | n/a | 0x80 | n/a | ef | | |
| AXI | 000 | 0x01 | 000 | | | ef |
| AHB/APB | 000 | n/a | 000 | | ef | |

TABLE 20
Big Endian - Byte Transfer (0xef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | | |
|---|---|---|---|---|---|---|
| MIPS | 111 | 0x01 | n/a | | | ef |
| OCP | n/a | 0x01 | n/a | | | ef |
| AXI | 111 | 0x80 | 000 | ef | | |
| AHB/APB | 111 | n/a | 000 | | ef | |

TABLE 21
Big Endian - Half-Word Transfer (0xcdef)

| | | Byte | A*SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |

| | | | | | | | | | |
|---|---|---|---|---|---|---|---|---|---|
| MIPS | 000 | 0xC0 | n/a | cd | ef | | | | |
| OCP | n/a | 0xC0 | n/a | cd | ef | | | | |
| AXI | 000 | 0x03 | 001 | | | | | ef | cd |
| AHB/APB | 000 | n/a | 001 | | | cd | ef | | |

TABLE 22
Big Endian - Half-Word Transfer (0xcdef)

| | | Byte | A * SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |
| MIPS | 110 | 0x03 | n/a | | | | | | | cd | ef |
| OCP | n/a | 0x03 | n/a | | | | | | | cd | ef |
| AXI | 110 | 0xC0 | 001 | ef | cd | | | | | | |
| AHB/APB | 110 | n/a | 001 | | | cd | ef | | | | |

TABLE 23
Big Endian - Word Transfer (0x89abcdef)

| | | Byte | A * SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |
| MIPS | 000 | 0xF0 | n/a | 89 | ab | cd | ef | | | | |
| OCP | n/a | 0xF0 | n/a | 89 | ab | cd | ef | | | | |
| AXI | 000 | 0x0F | 010 | | | | | ef | cd | ab | 89 |
| AHB/APB | 000 | n/a | 010 | | | | | 89 | ab | cd | ef |

TABLE 24
Big Endian - Word Transfer (0x89abcdef)

| | | Byte | A * SIZE | Data Bus | | | | | | | |
|---|---|---|---|---|---|---|---|---|---|---|---|
| Bus | Addr[2:0] | En | HSIZE | 63:56 | 55:48 | 47:40 | 39:32 | 31:24 | 23:16 | 15:8 | 7:0 |
| MIPS | 100 | 0xF0 | n/a | | | | | 89 | ab | cd | ef |
| OCP | n/a | 0x0F | n/a | | | | | 89 | ab | cd | ef |
| AXI | 100 | 0xF0 | 010 | ef | cd | ab | 89 | | | | |
| AHB/APB | 100 | n/a | 010 | 89 | ab | cd | ef | | | | |

TABLE 25
Big Endian - Double-Word Transfer (0x0123456789abcdef)

| | | |
|---|---|---|
| Byte | A * SIZE | Data Bus |

| Bus | Addr[2:0] | En | HSIZE | 63:56 | 55:48 | 47:40 | 39:32 | 31:24 | 23:16 | 15:8 | 7:0 |
|---|---|---|---|---|---|---|---|---|---|---|---|
| MIPS | 000 | 0xFF | n/a | 01 | 23 | 45 | 67 | 89 | ab | cd | ef |
| OCP | n/a | 0xFF | n/a | 01 | 23 | 45 | 67 | 89 | ab | cd | ef |
| AXI | 000 | 0xFF | 011 | ef | cd | ab | 89 | 67 | 45 | 23 | 01 |
| AHB/APB | 000 | n/a | 011 | 89 | ab | cd | ef | 01 | 23 | 45 | 67 |

Tables 19, 20, 21, 22, 23, 24, and 25 show that the boundaries between the different endian schemes are between double-word to byte invariant at the OCP to AXI bridge and byte to word invariant at the BP137-AXI to AHB-lite bridge. The MIPS processor 206 double-word invariant endian scheme rides on the endian-neutral OCP bus 208 transparently. It needs to be converted to AXI byte invariant endian scheme. A reasonable place to do this is in the Ocp2Axi bridge since this is the point where the data transitions between the double-word and byte invariant endian schemes.

The Ocp2Axi bridge 207 will perform the double-word to byte invariant endian scheme conversion. For little endian systems specified with the input signal BIGEND being low, no byte steering will be performed. For big endian systems specified with the input signal BIGEND being high, the following byte steering will take place for read and write data:

Byte 0 to Byte 7,

Byte 1 to Byte 6,

Byte 2 to Byte 5,

Byte 3 to Byte 4,

Byte 4 to Byte 3,

Byte 5 to Byte 2,

Byte 6 to Byte 1, and

Byte 7 to Byte 0.

The AXI byte invariant endian scheme needs to be converted to AHB/APB word invariant endian scheme. A reasonable place to do this is after the BP137-AXI to AHB-lite Bridge, since this is where the data transitions between byte and word invariant endian schemes. A block called AhbEndian is placed next to the BP137-AXI to AHB-lite Bridge, as shown in FIG. 2, to perform the byte to word invariant endian scheme conversion. For little endian systems specified by BIGEND, no byte steering is performed. For big endian systems specified by BIGEND, the following byte steering takes place for read and write data:

Byte 0 to Byte 3,

Byte 1 to Byte 2,

Byte 2 to Byte 1,

Byte 3 to Byte 0,

Byte 4 to Byte 7,

Byte 5 to Byte 6,

Byte 6 to Byte 5, and

Byte 7 to Byte 4.

The APB Endian Mux (multiplexer), shown in FIG. 2, is used to convert APB data bus information between little and big endian formats. Some of the APB peripherals use only 8-bit or 16-bit data buses, do not have a BIGEND signal and only support little endian format. The APB Endian Mux steers the 8-bit and 16-bit information to or from the proper byte lanes of the AHB data bus for big endian accesses. This endian mux is not part of the double-word, word or byte invariant endian scheme conversion implementation, but converts between little and big endian formats for the AHB word invariant endian scheme.

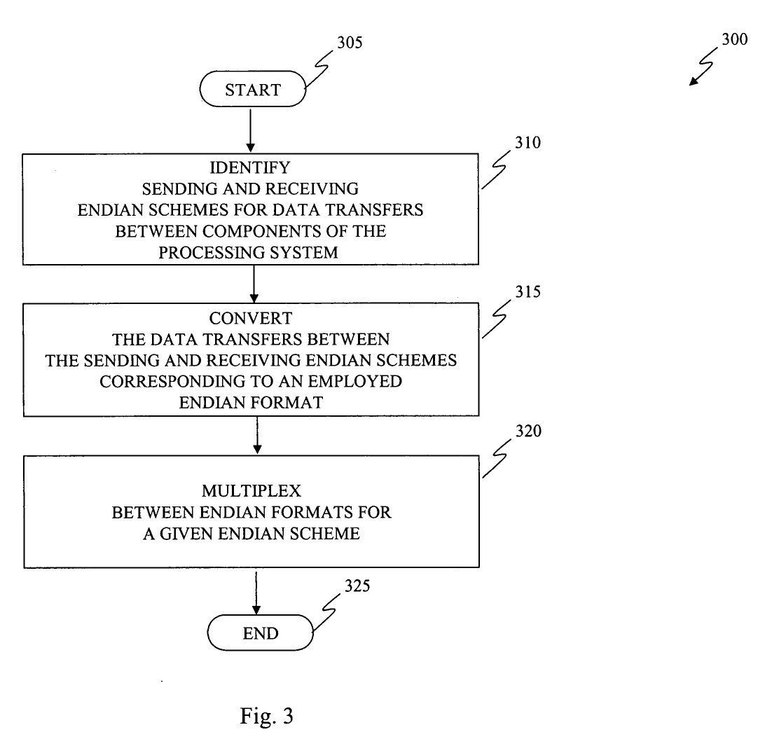

Turning now to FIG. 3, illustrated is a flow diagram of an embodiment of a method of endian mapping, generally designated 300, carried out in accordance with the principles of the present invention. The method 300 is for use with a processing system and starts in a step 305. Then, in a step 310, sending and receiving endian schemes are identified for data transfers between components of the processing system. In the illustrated embodiment, the endian schemes are selected from the group consisting of byte invariant, half-word invariant, word invariant and double-word invariant.

In a step 315, the data transfers are converted between the sending and receiving endian schemes corresponding to an endian format employed by the respective endian schemes. Each of the sending and receiving endian schemes may be identified employing at least one of a static and a dynamic endianness signal. The endian format is selected from the group consisting of a little endian format and a big endian format. In the illustrated embodiment, byte steering is employed to convert the data transfers between the sending and receiving endian schemes that correspond to a big endian format. The big endian format may be indicated by employing a hardware signal. Where a little endian format is employed, byte steering is not required. This action allows each component of the processing system to send and receive data employing its native endian scheme. In the illustrated embodiment, a step 320 further includes providing multiplexing between endian formats, when both big and little endian formats are not supported for a given endian scheme. The method 300 ends in a step 325.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing an endian mapping engine, a method of endian mapping and a processing system employing the engine or the method have been presented. Advantages include the ability for each component in the processing system to send and receive data using its native double-word, word, half-word or byte invariant endian scheme. Additionally, both big and little endian formats may be supported. When employing a big endian format, byte steering is required when crossing an endian scheme boundary in the processing system. Embodiments of the present invention allow performance enhancements and time-to-market advantages to be achieved by tailoring a differing endianness collection of components to form the processing system.

Although the present invention has been described in detail, those skilled in the art should understand that they can make various changes, substitutions and alterations herein without departing from the spirit and scope of the invention in its broadest form.

What is claimed is:

1. An endian mapping engine for use with a processing system, comprising:
an identification unit configured to identify sending and receiving endian schemes for data transfers between components of said processing system; and
a conversion unit coupled to said identification unit and configured to convert said data transfers between said sending and receiving endian schemes corresponding to an employed endian format.

2. The engine as recited in claim 1 further comprising a multiplexing unit coupled to said identification unit and configured to provide multiplexing between endian formats for a given endian scheme.

3. The engine as recited in claim 1 wherein endian schemes for data transfers are selected from the group consisting of:
byte invariant;
half-word invariant;
word invariant; and
double-word invariant.

4. The engine as recited in claim 1 wherein each of said sending and receiving endian schemes is identified by employing at least one of a static and a dynamic endianness signal.

5. The engine as recited in claim 1 wherein said endian format is selected from the group consisting of:
a little endian format; and
a big endian format.

6. The engine as recited in claim 1 wherein byte steering is employed to convert said data transfers between said sending and receiving endian schemes.

7. The engine as recited in claim 6 wherein said byte steering corresponds to a big endian format.

8. The engine as recited in claim 1 wherein a hardware signal is employed to indicate the use of a big endian format.

9. a method of endian mapping for use with a processing system, comprising:
identifying sending and receiving endian schemes for data transfers between components of said processing unit; and
converting said data transfers between said sending and receiving endian schemes corresponding to an employed endian format.

10. The method as recited in claim 9 further comprising providing multiplexing between endian formats for a given endian scheme.

11. The method as recited in claim 9 wherein endian schemes for data transfers are selected from the group consisting of:
byte invariant;
half-word invariant;
word invariant; and
double-word invariant.

12. The method as recited in claim 9 wherein each of said sending and receiving endian schemes is identified by employing at least one of a static and a dynamic endianness signal.

13. The method as recited in claim 9 wherein said endian format is selected from the group consisting of:
a little endian format; and
a big endian format.

14. The method as recited in claim 9 wherein byte steering is employed to convert said data transfers between said sending and receiving endian schemes.

15. The method as recited in claim 14 wherein said byte steering corresponds to a big endian format.

16. The method as recited in claim 9 wherein a hardware signal is employed to indicate the use of a big endian format.

17. A processing system, comprising:
a processor block employing at least one processor;
an interconnect block, coupled to said processor block, employing an input-output bus;
a peripheral block, coupled to said interconnect block, employing at least one peripheral; and
an endian mapping engine coupled to said processor, interconnect and peripheral blocks, including:
an identification unit that identifies sending and receiving endian schemes for data transfers between components of said processing system, and
a conversion unit, coupled to said identification unit, that converts said data transfers between said sending and receiving endian schemes corresponding to an employed endian format.

18. The system as recited in claim 17 further comprising a multiplexing unit, coupled to said identification unit, that provides multiplexing between endian formats for a given endian scheme.

19. The system as recited in claim 17 wherein endian schemes for data transfers are selected from the group consisting of:
byte invariant;
half-word invariant;
word invariant; and
double-word invariant.

20. The engine as recited in claim 17 wherein each of said sending and receiving endian schemes is identified by employing at least one of a static and a dynamic endianness signal.

21. The system as recited in claim 17 wherein said endian format is selected from the group consisting of:
a little endian format; and
a big endian format.

22. The system as recited in claim 17 wherein byte steering is employed to convert said data transfers between said sending and receiving endian schemes.

23. The system as recited in claim 22 wherein said byte steering corresponds to a big endian format.

24. The engine as recited in claim 17 wherein a hardware signal is employed to indicate the use of a big endian format.
